(19) United States
(12) Patent Application Publication
(10) Pub. No.: US 2024/0284422 A1
(43) Pub. Date: Aug. 22, 2024

(54) DEVICES AND METHODS FOR IMPROVED UPLINK THROUGHPUT

(71) Applicant: Apple Inc., Cupertino, CA (US)

(72) Inventors: Jochen O Schrattenecker, Alberndorf in der Riedmark (AT); Stephan Henzler, Munich (DE)

(21) Appl. No.: 18/423,034

(22) Filed: Jan. 25, 2024

Related U.S. Application Data
(60) Provisional application No. 63/446,268, filed on Feb. 16, 2023.

(51) Int. Cl. H04W 72/0453; H04B 7/0413

(52) U.S. Cl. CPC H04W 72/0453; H04B 7/0413

(57) ABSTRACT

User equipment may include a transmitter coupled to an antenna to enable the user equipment to transmit data with a base station and/or the wireless communication network. In certain instances, the user equipment may operate in a double multi-in multi-out (MIMO) configuration with or without switching. In the double MIMO with switching configuration, the user equipment may transmit data via two antennas on a first frequency band and switch to transmit additional data via the two antennas on a second frequency band. In the double MIMO without switching configuration, the user equipment may concurrently transmit data via two antennas on a first frequency band and transmit second data via two additional antennas on a second frequency band. Additionally, the user equipment may operate in a PC1.5 configuration using high power via two or more antennas.

### CROSS-REFERENCE TO RELATED APPLICATION

This application claims the benefit of U.S. Provisional Application No. 63/446,268, filed Feb. 16, 2023, entitled “DEVICES AND METHODS FOR IMPROVED UPLINK THROUGHPUT,” the disclosure of which is incorporated by reference in its entirety for all purposes.

### BACKGROUND

The present disclosure relates generally to wireless communication, and more specifically to increasing uplink throughput in wireless communication devices.

In a wireless communication device, a transmitter and a receiver may each be coupled to one or more antennas to enable the device to both transmit and receive wireless signals. In particular, the transmission of wireless signals may be regulated by standards or protocols, such as 3rd Generation Partnership Project (3GPP) standards. For example, uplink switching operating modes for the device may be defined by 3GPP standards, such as switching between transmitting on a first frequency band with one or more component carrier(s) and transmitting on a second frequency band with one or more component carriers. However, transmitting on multiple frequency bands (e.g., the first and second frequency bands) using multiple antennas on each frequency band (e.g., multiple or double multi-in multi-out (MIMO) transmission), either at separate times (e.g., switching between the transmission on the first frequency band and transmission on the second frequency band) or concurrently (e.g., without switching between transmission on the two frequency bands) may not be implemented on the device or defined by a standard.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, a non-transitory computer-readable medium, comprising instructions that, when executed by one or more processors, are configured to cause the one or more processors to receive an indication of a frequency band and a power class, transmit first user data on a first frequency band via a first set of transmitters of a plurality of transmitters of a device in a first multi-input multi-output (MIMO) configuration based on operational characteristics of the device, and transmit second user data on a second frequency band via a second set of transmitters of the plurality of transmitters in a second MIMO configuration based on the operational characteristics.

In another embodiment, a method may include receiving, via a receiver of a base station, a first indication of transmission capabilities of a user equipment, and transmitting, via a transmitter of the base station, a second indication of a power class and a plurality of frequency bands to the user equipment. The method may also include sending and receiving, via the transmitter and the receiver, user data to and from the user equipment based on the first indication and the user equipment being configured to transmit first user data using a first pair of transmitters in a first multi-in multi-out (MIMO) configuration using a first frequency band of the plurality of frequency bands and transmit second user data using a second pair of transmitters in a second MIMO configuration using a second frequency band of the plurality of frequency bands, the second frequency band being different from the first frequency band.

In yet another embodiment, a user equipment may include four antennas, four transmitters respectively coupled to the four antennas, and processing circuitry coupled to the four transmitters. The processing circuitry may operate the four transmitters in a double multi-in multi-out (MIMO) configuration based on operational characteristics of the user equipment being above a threshold, transmit first data via a first antenna of the four antennas on a first frequency band, transmit second data via a second antenna of the four antennas on the first frequency band, transmit third data via a third antenna of the four antennas on a second frequency band, and transmit fourth data via a fourth antenna of the four antennas on the second frequency band.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of a user equipment, according to embodiments of the present disclosure;

FIG. 2 is a functional diagram of the user equipment of FIG. 1, according to embodiments of the present disclosure;

FIG. 3 is a schematic diagram of a transmitter of the user equipment of FIG. 1, according to embodiments of the present disclosure;

FIG. 4 is a schematic diagram of a communication system including the user equipment of FIG. 1 communicatively coupled to a wireless communication network supported by base stations, according to embodiments of the present disclosure;

FIG. 5 is a flowchart of a method for configuring the user equipment of FIG. 1 in a double multi-in multi-out (MIMO) or high power configuration, according to embodiments of the present disclosure;

FIG. 6 is a functional diagram of the user equipment of FIG. 1 with two transmitters and two antennas, according to embodiments of the present disclosure;

FIG. 7 is a functional diagram of the user equipment of FIG. 1 with four transmitters and four antennas, according to embodiments of the present disclosure; and

FIG. 8 is a flowchart of a method for configuring the user equipment of FIG. 1 to transmit wireless signals in a double MIMO configuration without switching and using two intra-band component carriers (CCs) per transmission chain, a double MIMO configuration without switching and using one intra-band CC per transmission chain, or a double MIMO configuration with switching, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near.” “about.” “close to,” and/or “substantially” should be understood to mean including close to a target (e.g., design, value, amount), such as within a margin of any suitable or contemplatable error (e.g., within 0.1% of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to increasing throughput of wireless signals using two or more transmission chains (e.g., each having a transmitter coupled to an antenna) on multiple frequency bands. In particular, the 3^{rd} Generation Partnership Project (3GPP) standards divides the 5^{th} generation (5G) spectrum resources into two frequency ranges, frequency range one (FR1) and frequency range two (FR2). The FR1 includes low frequency bands (e.g., less than or “sub-” 6 gigahertz. (GHz)), while FR2 includes higher frequency bands (e.g., greater than or equal to 6 GHZ, such as millimeter wave (mmWave)). Within FR1, the 3GPP standards define multiple intra-bandwidth classes based on a number of component carriers (CC) and an aggregated bandwidth. For example, carrier aggregation (CA) bandwidth class A may be defined by one intra-band CC and an aggregated bandwidth up to 100 megahertz. (MHz), CA bandwidth class B may be defined by two intra-band CCs and an aggregated bandwidth up to 100 MHZ, and CA bandwidth class C may be defined by two intra-band CCs and an aggregated bandwidth up to 200 MHZ (transmission bandwidth up to 100 MHz for each CC).

With the foregoing in mind, the 3GPP standards also defines one or more uplink switching operating modes for the user equipment. In particular, the 3GPP standards defines multiple uplink operating modes with separate transmission on either a first frequency band and a second frequency band and switching between the frequency bands. In a first uplink operating mode, the user equipment may transmit on the first frequency band via one transmission chain (e.g., a transmitter coupled to an antenna) using one intra-band CC, thereby operating in a single carrier (SC) configuration. The user equipment may then switch to transmitting on the second frequency band via two transmission chains using one intra-band CC. thereby operating in a multi-in multi-out (MIMO) configuration. In this way, the user equipment may switch between the SC configuration and the MIMO configuration. In another example, the 3GPP standards define a second uplink operating mode in which the user equipment transmits on the first frequency band via two transmission chains using one intra-band CC and then switches transmissions to the second frequency band via the two transmission chains using one-intra-band CC. Both transmissions may be performed in the MIMO configuration. As such, the user equipment may transmit using a SC, double MIMO configuration. Still in another example, a third uplink operating mode may include the user equipment transmitting on the first frequency band via one transmission chain using one intra-band CC, thereby operating in a CA configuration. The user equipment may then switch to transmitting on the second frequency band via two transmission chains using two intra-band CCs, thereby operating in the MIMO configuration. In yet another example, a fourth uplink operating mode may include the user equipment transmitting on the first frequency band via two transmission chains using one intra-band CC and switching to transmitting on the second frequency band via the two transmission chains using two intra-band CCs. As such, the user equipment may transmit in the CA configuration and switch to the double MIMO configuration. In certain instances, switching transmissions from the first frequency band to the second frequency band may result in latency and reduced uplink throughput. For example, the user equipment may power down the transmitter, reset phase-locked loops for additional CCs, reset a frequency (e.g., frequency band), power up the transmitter, or any combination thereof in order to switch between the frequency bands. The switching steps may result in a latency of thirty to one-hundred twenty microseconds, or more.

Embodiments of the present disclosure provide various apparatuses and techniques to increase uplink throughput using concurrent (e.g., via multiple or double) MIMO transmission on multiple frequency bands, with or without switching. For example, the user equipment may transmit data in a double MIMO configuration with switching (e.g., switching between the MIMO configurations). To this end, the user equipment may include multiple transmission chains (e.g., each having a transmitter coupled to an antenna). The user equipment may concurrently transmit data on a first frequency band via a first pair of transmission chains using two intra-band CCs to one or more receivers of the base station in the MIMO configuration. The user equipment may then switch to transmitting on a second frequency band (e.g., different from the first frequency band) via the first pair of transmission chains using another two intra-band CCs in the MIMO configuration. As such, the user equipment may transmit using the double MIMO configuration, or four MIMO layer (each layer corresponding to a transmission chain) with switching. Moreover, in some cases, each transmission chain of the pair of transmission chains may transmit a different data stream, thereby improving uplink throughput of the user equipment. Additionally or alternatively, each transmission chain of a pair of transmission chains may transmit the same data stream, thereby increasing transmission power of the user equipment.

In other instances, the user equipment may transmit in the double MIMO configuration without switching. For example, the user equipment may include the first pair of transmission chains and a second pair of transmission chains, or four transmitters respectively coupled to four antennas. The user equipment may transmit on a first frequency band via the first pair of transmission chains using one intra-band CC and concurrently transmit on a second frequency band via the second pair of transmission chains using one intra-band CC, thereby operating in the double MIMO configuration without switching. The first frequency band and the second frequency band may fall under CA intra-bandwidth class A. The CA intra-bandwidth class A may be defined by one intra-band CC and an aggregated bandwidth up to 100 megahertz (MHZ). In another example, the user equipment may transmit on the first frequency band via the first pair of transmission chains using two intra-band CCs and concurrently transmit on the second frequency band via the second pair of transmission chains using two intra-band CCs. The first frequency band and the second frequency band may fall under CA intra-bandwidth class B or CA intra-bandwidth class C. The CA bandwidth class B may be defined by two intra-band CCs and an aggregated bandwidth up to 100 MHz and CA bandwidth class C may be defined by two intra-band CCs and an aggregated bandwidth up to 200 MHZ (transmission bandwidth up to 100 MHz for each CC. Indeed, each transmission chain may transmit a different data stream, thereby improving uplink throughput.

Additionally or alternatively, the user equipment may transmit at high power to increase transmission reliability. Transmitting data at a high power may increase a transmission range and/or a likelihood that the data will be received in comparison to transmitting data at a low power. For example, the user equipment may operate at high power when the user equipment may be at an edge of wireless coverage provided by the base station and/or based on a characteristic of transmission data being greater than a threshold (e.g., high priority, high volume of data). The user equipment may operate at a Power Class 2 (e.g., +26 dBm) and transmit same (or substantially similar) data on the first pair of transmission chains and/or the second pair of transmission chains. Transmitting same (or substantially similar) data on a first transmission chain and a second transmission chain may provide a power boost (e.g., increase transmission power power) for the transmission. For example, the user equipment may experience a power boost of +3 dBm. As such, the user equipment may transmit using a Power Class 1.5 (e.g., +29 dBm), which may be higher than Power Class 2. In this way, the user equipment may increase transmission range and/or reliability.

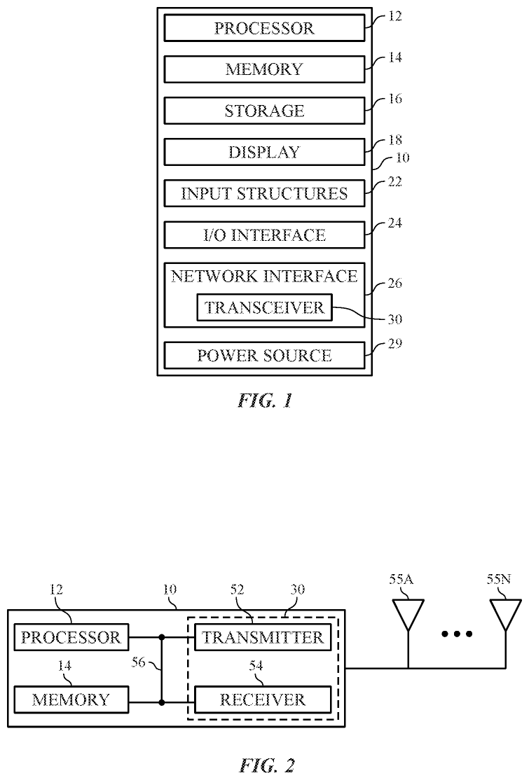

FIG. 1 is a block diagram of a user equipment 10, according to embodiments of the present disclosure. The user equipment 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the user equipment 10.

By way of example, the user equipment 10 may include any suitable computing device, including a desktop or notebook computer, a portable electronic or handheld electronic device such as a wireless electronic device or smartphone, a tablet, a wearable electronic device, and other similar devices. In additional or alternative embodiments, the user equipment 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the user equipment 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the user equipment 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the user equipment 10 to provide various functionalities.

In certain embodiments, the display 18 may facilitate users to view images generated on the user equipment 10. In some embodiments, the display 18 may include a touch screen, which may facilitate user interaction with a user interface of the user equipment 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the user equipment 10 may enable a user to interact with the user equipment 10 (e.g., pressing a button to increase or decrease a volume level). The I/O interface 24 may enable user equipment 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution® (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the user equipment 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. In particular, the transceiver 30 may include one or more transmission chains (e.g., each having a transmitter coupled to an antenna) transmitting wireless signals on multiple frequency bands in a multi-in multi-out (MIMO) configuration, and/or a double MIMO configuration, which may increase throughput of wireless signals. For example, when operating in a single carrier configuration, the transceiver 30 may transmit on a frequency band via one transmission chain using one intra-band component carrier (CC). When operating in the MIMO configuration, the transceiver 30 may transmit on a frequency band via two transmission chains using two intra-band CCs. In certain instances, the transceiver 30 may switch from transmitting on the frequency band to transmitting on an additional frequency band using the two transmission chains and two intra-band CCs, thereby operating in a double-MIMO configuration. Additionally or alternatively, the transceiver 30 may transmit the same data on both transmission chains, which may increase transmission reliability. The power source 29 of the user equipment 10 may include any suitable source of power, such as a rechargeable lithium polymer (Li-poly) battery and/or an alternating current (AC) power converter.

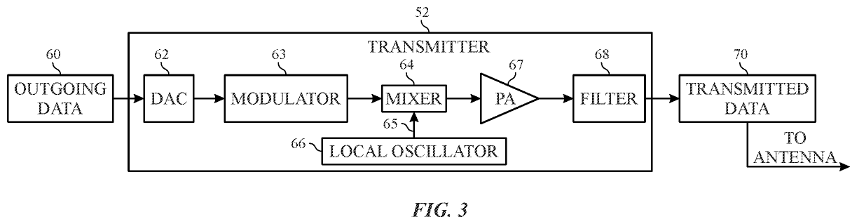

FIG. 2 is a functional diagram of the user equipment 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

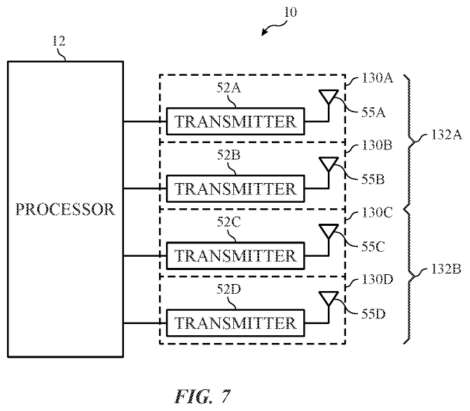

The user equipment 10 may include the transmitter 52 and/or the receiver 54 that respectively enable transmission and reception of signals between the user equipment 10 and an external device via, for example, a network (e.g., including base stations or access points) or a direct connection. As illustrated, the transmitter 52 and the receiver 54 may be combined into the transceiver 30. Although the illustrated user equipment 10 includes a transmitter 52 and a receiver 54, the user equipment 10 may include any suitable number of transmitters 52 and receivers 54. As further discussed with respect to FIGS. 6 and 7, the user equipment 10 may include two or more transmitters 52 respectively coupled to an antenna 55 that may concurrently operate to increase throughput of wireless signals transmitted by the user equipment 10.

The user equipment 10 may also have one or more antennas 55A-55N (e.g., two antennas, four antennas, six antennas, eight antennas) electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The user equipment 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the user equipment 10 may be coupled together by a bus system 56. The bus system 56 may include a data bus, for example, as well as a power bus, a control signal bus, and a status signal bus, in addition to the data bus. The components of the user equipment 10 may be coupled together or accept or provide inputs to each other using some other mechanism.

FIG. 3 is a block diagram of a transmitter 52 (e.g., transmit circuitry, having or part of a transmission chain) that may be part of the transceiver 30, according to embodiments of the present disclosure. As illustrated, the transmitter 52 may receive outgoing data 60 in the form of a digital signal to be transmitted via the one or more antennas 55. A digital-to-analog converter (DAC) 62 of the transmitter 52 may convert the digital signal to an analog signal, and a modulator 63 may combine the converted analog signal with a carrier signal. A mixer 64 may combine the carrier signal with a local oscillator signal 65 (which may include quadrature component signals) from a local oscillator 66 to generate a radio frequency (RF) signal. A power amplifier (PA) 67 receives the radio frequency signal from the mixer 64, and may amplify the modulated signal to a suitable level to drive transmission of the signal via the one or more antennas 55. A filter 68 (e.g., filter circuitry and/or software) of the transmitter 52 may then remove undesirable noise from the amplified signal to generate transmitted data 70 to be transmitted via the one or more antennas 55. The filter 68 may include any suitable filter or filters to remove the undesirable noise from the amplified signal, such as a bandpass filter, a bandstop filter, a low pass filter, a high pass filter, and/or a decimation filter. Additionally, the transmitter 52 may include any suitable additional components not shown, or may not include certain of the illustrated components, such that the transmitter 52 may transmit the outgoing data 60 via the one or more antennas 55. For example, the transmitter 52 may include an additional mixer and/or a digital up converter (e.g., for converting an input signal from a baseband frequency to an intermediate frequency). As another example, the transmitter 52 may not include the filter 68 if the power amplifier 67 outputs the amplified signal in or approximately in a desired frequency range (such that filtering of the amplified signal may be unnecessary). As discussed herein, the user equipment 10 may include two or more transmitters 52 to increase uplink throughput using concurrent transmission on multiple frequency bands via the two or more transmitters 52.

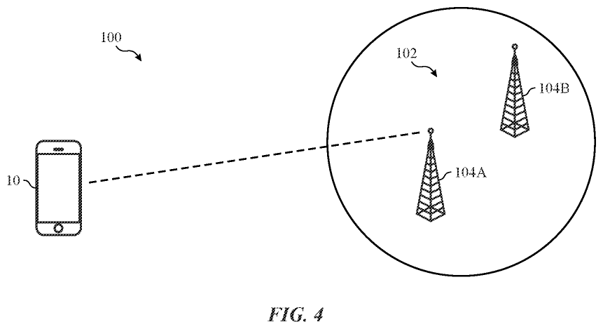

FIG. 4 is a schematic diagram of a communication system 100 including the user equipment 10 of FIG. 1 communicatively coupled to a wireless communication network 102 supported by base stations 104A, 104B (collectively 104), according to embodiments of the present disclosure. The user equipment 10 may transmit to the base stations 104 using the MIMO configuration and/or the double-MIMO configuration discussed herein. In particular, the base stations 104 may include Next Generation NodeB (gNodeB or gNB) base stations and may provide 5G/NR coverage via the wireless communication network 102 to the user equipment 10. The base stations 104 may include any suitable electronic device, such as a communication hub or node, that facilitates, supports, and/or implements the network 102. In some embodiments, the base stations 104 may include Evolved NodeB (eNodeB) base stations and may provide 4G/LTE coverage via the wireless communication network 102 to the user equipment 10. Each of the base stations 104 may include at least some of the components of the user equipment 10 shown in FIGS. 1 and 2, including one or more processors 12, the memory 14, the storage 16, the transceiver 30, the transmitter 52, the receiver 54, and the associated circuitry shown in FIGS. 3 and 4. It should be understood that while the present disclosure may use 5G/NR as an example specification or standard, the embodiments disclosed herein may apply to other suitable specifications or standards (e.g., such as the 4G/LTE specification, a sub-4G specification, a beyond 5G specification, such as a 6G specification, and so on). Moreover, the network 102 may include any suitable number of base stations 104 (e.g., one or more base stations 104, four or more base stations 104, ten or more base stations 104, and so on).

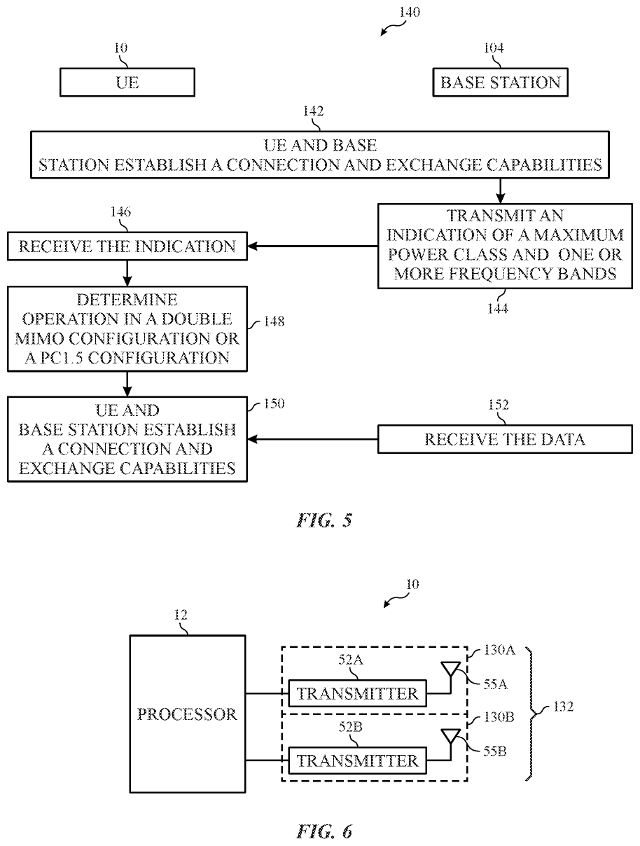

FIG. 5 is a flowchart of a method 140 for configuring the user equipment 10 in a double MIMO or high power configuration by the base station 104 and/or the wireless communication network 102, according to embodiments of the present disclosure. Any suitable device (e.g., a controller) that may control components of the user equipment 10, such as the processor 12, may perform the method 140. In some embodiments, the method 140 may be implemented by executing instructions stored in a tangible, non-transitory, computer-readable medium, such as the memory 14 or storage 16, using the processor 12. For example, the method 140 may be performed at least in part by one or more software components, such as an operating system of the user equipment 10, one or more software applications of the user equipment 10. and the like. While the method 140 is described using steps in a specific sequence, it should be understood that the present disclosure contemplates that the described steps may be performed in different sequences than the sequence illustrated, and certain described steps may be skipped or not performed altogether.

In process block 142, the user equipment 10 and the base station 104 establish a connection and exchange capabilities. To connect to the base station 104, the user equipment 10 may scan to detect one or more base stations 104 of the wireless communication network 102. In particular, the user equipment 10 may detect the base station 104 by receiving an RF signal when the user equipment 10 enters a coverage area of the base station 104 (e.g., a geographical region for which the base station 104 provides network coverage). The user equipment 10 may synchronize to the base station 104 by aligning its RF signal with the RF signal of the base station 104. Further, the base station 104 may broadcast or transmit system information (e.g., downlink data) indicative of frequency bands and/or power classes supported by the base station 104 and/or the wireless communication network 102. The system information may also include timing specifications, power specifications, Global Positioning System (GPS) or Global Navigation Satellite System (GNSS) coordinates, and/or other suitable information to enable the user equipment 10 to establish the connection with the base station 104. The user equipment 10 may receive the system information to establish a communication link (e.g., connection) with the base station 104 and the wireless communication network 102. For example, user data (e.g., data associated with one or more software applications executed by the processor 12, such as voice data, messaging data, media data, streaming data, gaming data, and so on) may be sent over a channel of the communication link that is allocated to the user equipment 10 by the base station 104 or the wireless communication network 102. Moreover, the user equipment 10 may monitor the communication link for a power (e.g., within a predetermined power class) used to transmit the user data. In other words, the base station 104 may transmit or receive user data to or from the user equipment 10 over the channel allocated to the user equipment 10 or the established communication link. Additionally or alternatively, the user equipment 10 may transmit an indication of its capabilities (e.g., uplink characteristics) to the base station 104. For example, the user equipment 10 may transmit an indication of a transmission power, a power class, and/or frequency bands supported by the user equipment 10. In another example, the user equipment 10 may transmit an indication of operational characteristics, such as a location (e.g., distance from the base station 104), an amount of battery power, an amount of data to be transmitted, and the like.

In process block 144, the base station 104 transmits an indication of a power class and one or more frequency bands. For example, the base station 104 may send an indication of a maximum power class and/or a maximum transmission power supported by the base station 104 and/or the wireless communication network 102. The power class supported by the wireless network 102 may include any suitable power class as specified by a standards body (e.g., the 3GPP), including Power Class 1.5 (PC1.5), Power Class 2 (PC2), Power Class 3 (PC3), and so on. In particular, regulatory bodies (e.g., FCC, CENLEC) may define a power emission limit or specific absorption rate that transmission power by the user equipment 10 may not exceed (e.g., for a period of time), and the power classes may be used to facilitate determining that such limits are not exceeded. For example, the PC1.5 may include a maximum transmission power of +29 dBm, the PC2 may include a maximum transmission power of +26 dBm, and the PC3 may include a maximum transmission power of +23 dBm. Transmitting at a higher power may increase a transmission range in comparison to transmitting at a lower power. In another example, the base station 104 may transmit an indication of one or more frequency bands allocated to the user equipment 10 for transmissions. The indication may include a frequency range for transmitting the data (e.g., wireless signals), a number of intra-band CCs, a bandwidth of the CC. a CA bandwidth class, and the like. For example, the frequency band may include one or more ranges within FR1 (e.g., less than 6 GHZ). In another example, the CA bandwidth classes may include a CA bandwidth class A defined by one intra-band CC with a transmission bandwidth of up to 100 MHZ, or an aggregated bandwidth up to 100 MHZ. The CA bandwidth class B may be defined by two intra-band CCs and an aggregated bandwidth of up to 100 MHZ, and the CA bandwidth class C may be defined by two intra-band CCs and an aggregated bandwidth of up to 200 MHZ. It should be understood that while the present disclosure may use CA bandwidth classes A. B, and C as example bandwidth classes, the embodiments disclosed herein may apply to other suitable bandwidth classes (e.g., such as NR CA bandwidth class D to NR CA bandwidth class O). Additionally, while the present disclosure may use up to two intra-band CCs as an example number of intra-band CCs, it may be understood that any suitable number of intra-band CCs (e.g., two, three, four, five, six, seven, eight) with any suitable bandwidth (e.g., greater than 200 MHZ) may be applied to the embodiments disclosed herein.

In process block 146, the user equipment 10 receives the indication. For example, the user equipment 10 may receive via the receiver 54 the indication of the power class and/or the frequency bands supported by the base station 104 and/or wireless communication network 102. In another example, the user equipment 10 may receive via the receiver 54 an indication that PC1.5 may be supported by the base station 104 and/or the wireless communication network 102. Still in another example, the user equipment 10 may receive one or more frequency bands for transmission.

In process block 148, the user equipment 10 determines whether to operate in a double MIMO configuration or a PC1.5 configuration. The user equipment 10 may determine whether to operate in the double MIMO configuration or the PC1.5 configuration based on operational characteristics of the user equipment 10, such as determining an amount of data for transmitting, a priority of the data, a distance between the user equipment 10 and the base station 104, a state of charge of a power source of the user equipment 10, and the like. The user equipment 10 may compare the operational characteristics to one or more thresholds. For example, the user equipment 10 may operate in the double MIMO configuration if the amount of data to be transmitted is above a threshold amount. That is, the user equipment 10 may transmit different data streams via each antenna, thereby increasing an amount of data being transmitted. In another example, the user equipment 10 may operate in the PC1.5 configuration if the distance between the user equipment 10 and the base station 104 and/or if the priority of the data may be above a threshold. The user equipment 10 may be located at a cell edge, or an edge of the coverage area of the base station 104. Transmitting the data at a higher power class (e.g., higher maximum output power) may cause the data to be transmitted a further distance in comparison to a lower power class (e.g., lower maximum output power), or increase a likelihood of the data being received (e.g., of sufficient signal quality). As such, the user equipment 10 may determine to operate in the PC1.5 configuration.

In process block 150, the user equipment 10 transmits data in the double MIMO configuration or the PC1.5 configuration. In certain instances, the user equipment 10 may transmit in the double MIMO configuration with switching. For example, the user equipment 10 may include two antennas 55 that may each be coupled to a respective transmitter 52. The user equipment 10 may transmit via the two antennas 55 on a first frequency band in the MIMO configuration. That is, the user equipment 10 may transmit first data via a first antenna 55A and second data via a second antenna 55B. The second data that may be different from the first data. The user equipment 10 may then switch to transmitting via the two antennas on a second frequency band in the MIMO configuration. In this way, the user equipment 10 may transmit using the double MIMO configuration with switching (e.g., transmission switching). In other instances, the user equipment 10 may transmit in the double MIMO configuration without switching. For example, the user equipment 10 may include four antennas 55 that may each be coupled to a respective transmitter 52. All four antennas 55 may be active during transmission such that the user equipment 10 may concurrently perform double MIMO transmissions on two frequency bands without switching (e.g., between the frequency bands). For example, the user equipment 10 may concurrently transmit first data via a first antenna 55A and second data via a second antenna 55B on a first frequency band in the MIMO configuration. The user equipment 10 may also concurrently transmit third data via a third antenna 55C and fourth data via a fourth antenna 55D on a second frequency band in the MIMO configuration (e.g., as shown in FIG. 7 below). As such, the user equipment 10 may transmit in the double MIMO configuration over two different frequency bands without switching. In this way, the user equipment 10 may increase an amount of data being transmitted via the four antennas 55 and without switching between bands, thereby increasing uplink throughput. In other instances, the user equipment 10 may transmit using the PC1.5 configuration. For example, the user equipment 10 may enable the PC1.5 configuration and transmit first data on the first antenna 55A and the second antenna 55B. In another example, the user equipment 10 may also transmit second data on the third antenna 55C and the fourth antenna 55D in the PC1.5 configuration. Indeed, transmitting data in the PC1.5 configuration may increase a transmission distance of the data and/or data likelihood that the data is received. As such, uplink throughput and/or reliability of the user equipment 10 may be improved.

In process block 152, the base station 104 receives the data (e.g., user data). For example, the user equipment 10 may transmit the data via two or more antennas 55 in the double MIMO configuration and one or more receivers of the base station 104 may receive an indication of the data. In another example, the user equipment 10 may transmit the data using PC1.5 and the base station 104 may receive the data. The base station 104 and/or the wireless communication network 102 may subsequently process the data received from the user equipment 10. In this manner, the user equipment 10 may be configured for transmitting data via two or more antennas 55 in the double MIMO configuration or the PC1.5 configuration.

FIG. 6 illustrates a functional diagram of the user equipment 10 with two transmitters 52 and two antennas 55, according to embodiments of the present disclosure. In particular, the user equipment 10 may include the processor 12, a first transmitter 52A, a first antenna 55A, a second transmitter 52B, and/or a second antenna 55B, which may be communicatively coupled directly or indirectly (e.g., through another component, a communication bus, a network) to one another to transmit and/or receive signals to and from an external device (e.g., base station 104 described with respect to FIG. 4). The first transmitter 52A may be coupled to the first antenna 55A to form a first transmission chain 130A, and the second transmitter 52B may be coupled to the second antenna 55B to form a second transmission chain 130B. The first transmission chain 130A and the second transmission chain 130B may be referred to as a pair of transmission chains 132.

The user equipment 10 may cause the first pair of transmission chains 132 to transmit data to the base station 104 and/or the wireless communication network 102. For example, the user equipment 10 may cause the first pair of transmission chains 132 to transmit data on a first frequency band and switch to transmitting on a frequency second band that may be different from the first band. To this end, the user equipment 10 may include one or more local oscillators (e.g., local oscillator 66 described with respect to FIG. 3) to enable transmitting on the first frequency band and the second frequency band. For example, a first local oscillator may generate a first signal to modulate first outgoing data to generate a first RF signal, which may be transmitted by the pair of transmission chains 132 on the first frequency band, and a second local oscillator may generate a second signal to modulate second outgoing data to generate a second RF signal, which may be transmitted by the pair of transmission chains 132 on the second frequency band.

By way of example, the user equipment 10 may transmit in the double MIMO configuration with switching. That is, user equipment 10 may cause the pair of transmission chains 132 to transmit on the first frequency band, and then switch to causing the pair of transmission chains 132 to transmit on a second frequency band. The first transmission chain 130A may transmit first data using two intra-band CCs on the first frequency band and the second transmission chain 130B may transmit second data using the intra-band CCs. The user equipment 10 may then switch to transmitting additional data on the second frequency band. For example, the first transmission chain 130A may switch to transmitting third data using the two intra-band CCs on the second frequency band and the second transmission chain 130B may switch to transmitting fourth data using the two intra-band CCs. The first frequency band and/or the second frequency band may include CA bandwidth class B and/or CA bandwidth class C. If the first frequency band and/or the second frequency band includes CA bandwidth class B, each intra-band CC may include a bandwidth of up to 100 MHZ. As such, the user equipment 10 may transmit at an aggregated bandwidth of up to 200 MHz in the first frequency band, and an aggregated bandwidth of up to 200 MHz in the second frequency band. If the first frequency band and/or second frequency band includes CA bandwidth class C. the two intra-band CCs may include a bandwidth of up to 200 MHZ. As such, the user equipment 10 may transmit at an aggregated bandwidth of up to 400 MHZ in the first frequency band and/or an aggregated transmission frequency of up to 400 MHZ in the second frequency band. In this way, the user equipment 10 may transmit in the double MIMO configuration (e.g., four MIMO layer) with switching. Transmitting via two antennas 55A and 55B may reduce coupling (e.g., cross-talk) within the user equipment 10 and/or between the antennas 55 in comparison to using additional antennas, such as 3 antennas, 4 antennas, 5, antennas, and so on.

In certain instances, the user equipment 10 may transmit in the PC1.5 configuration. That is, the user equipment 10 may transmit first data via the first transmission chain 130A and first data the second transmission chain 130B. If the first frequency band and/or the second frequency band includes CA bandwidth class B, then the first transmission chain 130A may use two intra-band CCs and operate at a transmission bandwidth up to 100 MHZ. Since the data may be the same (or substantially similar) for the first transmission chain 130A and the second transmission chain 130B, the aggregated bandwidth of the user equipment 10 may be 100 MHZ, which may be half the transmission bandwidth in comparison to transmitting in the double MIMO configuration. As discussed herein, transmitting same (or substantially similar) data on two transmission chains 130 may provide a power boost to the user equipment 10 during the transmitting. The power boost may be an increase in power above the transmission power of a single transmission chain 130, which may increase a transmission distance of the data. In certain instances, the user equipment 10 may transmit in the PC1.5 configuration based on receiving an indication that the base station 104 and/or the wireless communication network 102 supports PC1.5. For example, the base station 104 may send an indication that PC2 may be a highest power class supported and the user equipment 10 may operate in the PC2 configuration based on the indication.

In certain instances, inter-band combinations with one or more DAC groups (e.g., DAC 62 described with respect to FIG. 3) may be supported by the user equipment 10. For example, one or more same DAC groups may be supported. In another example, one or more different DAC groups may be supported. Additionally or alternatively, downlink operations of the user equipment 10 may also be performed using the double MIMO configuration. That is, the first antenna 55A and the second antenna 55B may simultaneously receive data (e.g., downlink data) from the base station 104 and transmit the data to one or more receivers 54 of the user equipment 10.

In an instance, the user equipment 10 may switch transmitting between the MIMO configuration and the PC1.5 configuration. In certain instances, the user equipment 10 may cause the first pair of transmission chains 132 to transmit in the first frequency band in the MIMO configuration and switch to causing the first pair of transmission chains 132 to transmit in the second frequency band in the PC1.5 configuration, or vice versa. For example, the user equipment 10 may determine that the amount of data for transmitting may be above a threshold and cause the first pair of transmission chains 132 to transmit in the double MIMO configuration. In another example, the user equipment 10 may determine that the distance between the user equipment 10 and the base station 104 may be above a threshold, and switch to causing the first pair of transmission chains 132 to transmit in the second frequency band in the PC1.5 configuration.

FIG. 7 illustrates a functional diagram of the user equipment 10 with four transmitters 52 and four antennas 55, according to embodiments of the present disclosure. In particular, the user equipment 10 may include a first transmitter 52A coupled to a first antenna 55A, a second transmitter 52B coupled to a second antenna 55B, a third antenna 55C coupled to a third antenna 55C, and a fourth antenna 55D coupled to a fourth antenna 55D, which may be communicatively coupled directly or indirectly to one another to transmit and/or receive signals to and from an external device (e.g., base station 104 described with respect to FIG. 4). The user equipment 10 may include a first transmission chain 130A including the first transmitter 52A and the first antenna 55A, a second transmission chain 130B including the second transmitter 52B, and the second antenna 55B, a third transmission chain 130C including the third transmitter 52C and the third antenna 55C, and a fourth transmission chain 130D including the fourth transmitter 52D and the fourth antenna 55D for transmitting and/or receiving signals to and from the base station 104 and/or the wireless network 102.

The transmission chains 130 may be referred to as a first pair of transmission chains 132A and a second pair of transmission chains 132B. The first pair of transmission chains 132A may refer to the first transmission chain 130A and the second transmission chain 130B. The second pair of transmission chains 132B may refer to the third transmission chain 130C and the fourth transmission chain 130D. In other instances, the first pair of transmission chains 132A and/or the second pair of transmission chains 132B may refer to the second transmission chain 130B and the third transmission chain 130C, the first transmission chain 130A and the fourth transmission chain 130D, or any suitable combination of transmission chains 130. Moreover, the user equipment 10 may transmit on the first frequency band via the first pair of transmission chains 132A and transmit on the second frequency band via the second pair of transmission chains 132B. To this end, the user equipment 10 may include one or more local oscillators (e.g., local oscillator 66 described with respect to FIG. 3) to enable transmitting on the first frequency band and the second frequency band. For example, a first local oscillator may generate a first signal to modulate first outgoing data to generate a first RF signal, which may be transmitted by the first pair of transmission chains 132A on the first frequency band. A second local oscillator may generate a second RF signal to modulate second outgoing data, which may be transmitted by the second pair of transmission chains 132B on the second frequency band.

In an embodiment, the user equipment 10 may transmit in the double MIMO configuration without switching and each transmission chain 130 may use one intra-band CC. In an embodiment, the user equipment 10 may cause the first pair of transmission chains 132A to transmit on the first frequency band and concurrently cause the second pair of transmission chains 132B to transmit on the second frequency band. That is, the user equipment 10 may not switch between multiple frequency bands when transmitting. If the first frequency band and/or the second frequency band includes CA bandwidth class A. each intra-band CC may include a bandwidth of up to 100 MHZ. As such, the transmission chains 130 may transmit data using the one intra-band CC and an aggregated bandwidth up to 100 MHZ, or CA bandwidth class A. With four active transmission chains 130, the user equipment 10 may transmit at an aggregated bandwidth of up to 400 MHZ.

In the double MIMO configuration (e.g., four MIMO layer), the user equipment 10 may concurrently transmit first data via the first transmission chain 130A and second data via the second transmission chain 130B on the first frequency band and concurrently transmit third data via the third transmission chain 130C and fourth data via the fourth transmission chain 130D on the second frequency band. Concurrently transmitting data on two frequency bands may reduce latency caused by switching (and steps involved with switching) between the frequency bands, thereby increasing uplink throughput. In certain instances, transmitting data via the transmission chains 130 using one intra-band CC and lower bandwidths may reduce coupling between the transmission chains 130 in comparison to transmitting at higher bandwidths. In other instances, the user equipment 10 may perform downlink operations via the transmission chains 130 in a MIMO configuration to reduce coupling between the transmission chains 130.

In an embodiment, the user equipment 10 may operate in the double MIMO configuration without switching and each transmission chain 130 may use two intra-band CC. As discussed herein, the user equipment 10 may cause each transmission chain 130 to transmit different data and each pair of transmission chains 132 may transmit on a different frequency band. In certain instances, the first pair of transmission chains 132A may transmit first data and second data using two intra-band CCs on the first frequency band and the second pair of transmission chains 132B may transmit third data and fourth data using the two intra-band CCs on the second frequency band. If the first frequency band and/or the second frequency band includes CA bandwidth class B, the wo intra-band CCs may include an aggregated bandwidth of up to 100 MHZ. With all four active transmission chains 130, the user equipment 10 may transmit data via the first pair of transmission chains 132A and the second pair of transmission chains 132B at an aggregated bandwidth of up to 400 MHZ. If the first frequency band and/or the second frequency band includes CA bandwidth class C, the two intra-band CCs may include an aggregated bandwidth of up to 200 MH. As such, the user equipment 10 may transmit data via the two pair of transmission chains 132 at an aggregated bandwidth of up to 800 MHZ. The two intra-band CCs may be contiguous or non-contiguous. Indeed, increasing bandwidth of each transmission chain 130 and/or aggregated bandwidth of the user equipment 10 may improve uplink throughput. Moreover, concurrently transmitting different data streams via each transmission chain 130 without switching may improve uplink throughput.

In certain instances, the user equipment 10 may operate in the PC1.5 configuration. For example, the user equipment 10 may determine an amount of data to be transmitted may be below a threshold amount and initiate operation in the PC1.5 configuration. In another example, the user equipment 10 may determine a priority of the data may be above a threshold and initiate operation on the PC1.5 configuration. In the PC1.5 configuration, the user equipment 10 may transmit first data on the first frequency band via the first pair of transmission chains 132A and transmit second data on the second frequency band via the second pair of transmission chains 132B. As discussed herein, the user equipment 10 may via the transmitters 52 operate at PC2 and transmitting same (or substantially similar) via two antennas 55 may provide a power boost. As such, the user equipment 10 may transmit at high power, or in the PC1.5 configuration.

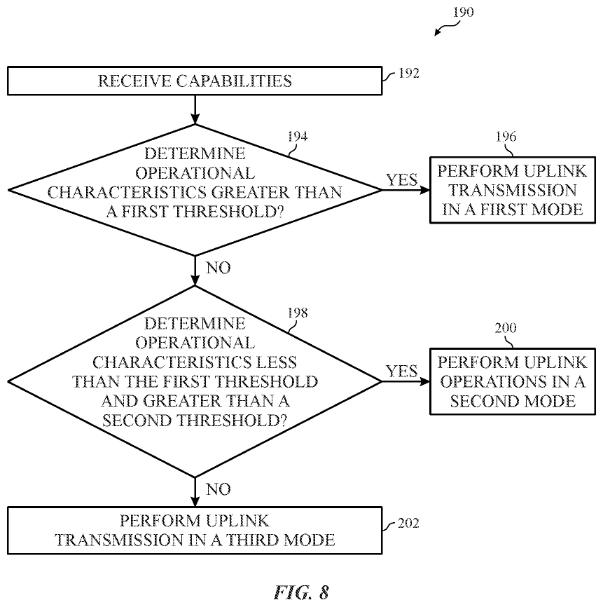

FIG. 8 illustrates a method 190 for configuring the user equipment 10 to operate in a first mode (e.g., a double MIMO configuration without switching and using two intra-band CCs per transmission chain, a second mode (e.g., a double MIMO configuration without switching and using one intra-band CC per transmission chain), or a third mode (e.g., a double MIMO configuration with switching), according to embodiments of the present disclosure. Any suitable device (e.g., a controller) that may control components of the user equipment 10, such as the processor 12, may perform the method 190. In some embodiments, the method 190 may be implemented by executing instructions stored in a tangible, non-transitory, computer-readable medium, such as the memory 14 or storage 16, using the processor 12. For example, the method 190 may be performed at least in part by one or more software components, such as an operating system of the user equipment 10, one or more software applications of the user equipment 10, and the like. While the method 190 is described using steps in a specific sequence, it should be understood that the present disclosure contemplates that the described steps may be performed in different sequences than the sequence illustrated, and certain described steps may be skipped or not performed altogether.

In process block 192, the user equipment 10 receives capabilities. For example, the user equipment 10 may receive a transmission power (e.g., a maximum transmission power), a power class (e.g., a maximum transmission class), and/or frequency bands supported by the base station 104 and/or the wireless communication network 102, such as in process block 146 described with respect to FIG. 5. Based on the transmission power, for example, the user equipment 10 may determine if higher power classes (e.g., PC1.5) may be supported by the base station 104 and/or the wireless communication network 102. If PC1.5 is supported, then the user equipment 10 may subsequently transmit at lower power classes (e.g., PC2, PC3) and/or in the double MIMO configuration. In some embodiments, the user equipment 10 determines or receives operational characteristics of the user equipment 10 (e.g., via the processor 12, the transceiver 30, transmitter 52, antenna 55). The operational characteristics may include an amount of data for transmitting, a priority of the data, a distance between the user equipment 10 and the base station 104, a state of charge of a power source of the user equipment 10, and the like.

In determination block 194, the user equipment 10 determines if operational characteristics are greater than a first threshold. In certain instances, the user equipment 10 may determine if one operational characteristic may be greater than the first threshold. For example, the user equipment 10 may determine if a state of charge of a power source (e.g., a current battery power) is above the first threshold. The first threshold may include a state of charge of the power source, such as 80% charge of the power source. 70% charge of the power source, 60% charge of the power source, and so on. The user equipment 10 may compare the state of charge to the first threshold. In another example, the user equipment 10 may determine if an amount of data and/or a priority of the data to be transmitted is above the first threshold. Still in another example, the user equipment 10 may determine if the distance between the user equipment 10 and the base station 104 is above the first threshold. That is, the user equipment 10 may be located at an edge of coverage provided by the base station 104 and transmitting the data at a higher power class may increase a likelihood that the data is received. In an embodiment, the user equipment 10 may apply a weighting system by assigning weights to each operational characteristic and determine if the aggregated, weighted operational characteristics may be greater than the first threshold.

If the user equipment 10 determines that operational characteristics are greater than the first threshold, then in process block 196, the user equipment 10 transmits in a first mode. For example, if the state of the power source and/or the amount of data to be transmitted is greater than the first threshold, then the user equipment 10 may transmit data in the first mode. In another example, if the distance between the user equipment 10 and the base station 104 may be greater than the first threshold, then the user equipment 10 may transmit the data in the first mode. Still in another example, if the priority of the data to be transmitted may be high, then the user equipment 10 may transmit the data in the first mode. For example, the user equipment 10 may transmit in the double MIMO configuration without switching and using two intra-band CCs per transmission chain 130. The user equipment 10 may include four active transmission chains 130 that each use two intra-band CCs and an aggregated bandwidth up to 200 MHZ. The user equipment 10 may cause the first transmission chain 130A to transmit first data on the first frequency band and cause the second transmission chain 130B to transmit second data on the first frequency band, and concurrently cause the third transmission chain 130C to transmit third data on the second frequency band and cause the fourth transmission chain 130D to transmit fourth data on the second frequency band. In this way, the user equipment 10 may transmit data in the double MIMO configuration mode without switching. In another example, the user equipment 10 may transmit in the PC1.5 configuration. For example, the user equipment 10 may cause the first pair of transmission chains 132A to transmit first data on the first frequency band and cause the second pair of transmission chains 132B to transmit second data on the second frequency band. As such, the user equipment 10 may implement a power boost and transmit at high power (e.g., +29 dBm). Transmitting in the PC1.5 configuration may increase reliability of the data being delivered to the base station 104. In certain instances, the user equipment 10 may operate in the MIMO configuration via the first pair of transmission chains 132A and operate in the PC1.5 configuration via the second pair of transmission chains 132B, or vice versa.

If the user equipment 10 determines that operational characteristics are less than the first threshold, then in process block 198, the user equipment 10 determines if the operational characteristics are less than the first threshold and greater than a second threshold. The second threshold may be less than the first threshold. For example, the second threshold may include the state of charge of the power source, such as 30% charge of the power source, 20% charge of the power source, 15% charge of the power source, and so on. The user equipment 10 may determine if the state of charge of the power source is less than the first threshold but greater than a second threshold. In another example, the second threshold may include a priority of the data to be transmitted, such as a medium priority or a low priority. As discussed herein, the user equipment 10 may apply the weighting system to each operational characteristic and determine if the aggregated, weighted operational characteristics are below the first threshold but greater than a second threshold.

If the operational characteristics are less than the first threshold and greater than the second threshold, then in process block 200, the user equipment 10 transmits in a second mode. For example, if the state of charge of the power source may be below the first threshold but greater than the threshold, then the user equipment 10 may transmit the data in the second mode. In another example, if the priority of the data may be below the first threshold but greater than the second threshold, then the user equipment 10 may transmit the data in the second mode. For example, the user equipment 10 may operate in the double MIMO configuration without switching and using one intra-band CC. The user equipment 10 may include four active transmission chains 130 that each use one intra-band CC and an aggregated bandwidth up to 100 MHz. In certain instances, transmitting with one intra-band CC and 100 MHz may reduce coupling between the transmission chains 130 and/or the antennas 55, which may improve uplink signal quality. Indeed, the user equipment 10 may cause the first transmission chain 130A to transmit first data and cause the second transmission chain 130B to transmit second data on the first frequency band, and concurrently cause the third transmission chain 130C to transmit third data and the fourth transmission chain 130D to transmit fourth data on the second frequency band. In this way, the user equipment 10 may transmit data in the double MIMO configuration mode without switching. In another example, the user equipment 10 transmit in the PC1.5 configuration with the four active transmission chains 130. The user equipment 10 may cause the first pair of transmission chains 132A to transmit first data on the first frequency band and cause the second pair of transmission chains 132B to transmit second data on the second frequency band. As such, the user equipment 10 may implement a power boost and transmit using high power. Still in another example, the user equipment 10 may operate in the MIMO configuration via the first pair of transmission chains 132A and operate in the PC1.5 configuration via the second pair of transmission chains 132B, or vice versa.

If the operational characteristics are less than the second threshold, then in process block 202, the user equipment 10 transmits in a third mode. For example, the user equipment 10 may determine that the state of charge of the power source may be below the second threshold and operate in the third mode. In an instance, the user equipment 10 may transmit in the double MIMO configuration with switching. The user equipment 10 may cause two active transmission chains 130 to transmit first data and second data on the first frequency band and switch to transmitting second data and third data on second frequency band. Each transmission chain 130 may transmit data using two intra-band CCs at an aggregated bandwidth up to 200 MHZ. As such, the user equipment 10 may transmit at an aggregated bandwidth of 400 MHz per frequency band. As such, the user equipment 10 may transmit in the double MIMO configuration with switching. In other instances, the user equipment 10 may transmit in the PC1.5 configuration using the two transmission chains 130. That is, the user equipment 10 may cause the two transmission chains 130 to transmit first data on the first frequency band and switch to transmitting second data on the second frequency band with the two transmission chains 130. In certain instances, causing two transmission chains 130 to transmit the data may be less resource intensive and/or power intensive in comparison to causing four transmission chains 130 to transmit. In other instances, transmitting with two active transmission chains 130 may decrease an amount of coupling in comparison to transmitting with four transmission chains 130. As such, uplink signal quality may be improved. In certain instances, the user equipment 10 may include four transmission chains 130 and activate two of the four transmission chains 130 to transmit in the third mode. In other instances, the user equipment 10 may include less than four transmission chains 130 and the method 190 may skip to the process block 202.

It is understood that the method 190 may be performed if the user equipment 10, base station 104, and/or the wireless communication network 102 supports the double MIMO configuration without switching and/or the PC1.5 configuration. For example, the user equipment 10 may include less than four transmission chains 130 and the method 190 may skip to process block 202. As such, the user equipment 10 may transmit using the third mode. In another example, the user equipment 10 may receive the capabilities in process block 192 and determine that the PC1.5 configuration may not be supported. As such, the user equipment 10 may transmit using the double MIMO configuration and/or skip the method 190.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A non-transitory computer-readable medium, comprising instructions that, when executed by one or more processors, are configured to cause the one or more processors to:
receive an indication of a frequency band and a power class;
transmit first user data on a first frequency band via a first set of transmitters of a plurality of transmitters of a device in a first multi-input multi-output (MIMO) configuration based on operational characteristics of the device; and
transmit second user data on a second frequency band via a second set of transmitters of the plurality of transmitters in a second MIMO configuration based on the operational characteristics.

2. The non-transitory computer-readable medium of claim 1, wherein the instructions, when executed by the one or more processors, are configured to cause the one or more processors to switch transmitting from the first frequency band to the second frequency band prior to transmitting the second user data on the second frequency band, the first set of transmitters being the same as the second set of transmitters.

3. The non-transitory computer-readable medium of claim 1, wherein the instructions, when executed by the one or more processors, are configured to cause the one or more processors to switch transmitting from the first frequency band to the second frequency band based on the operational characteristics being below a first threshold.

4. The non-transitory computer-readable medium of claim 1, wherein the instructions, when executed by the one or more processors, are configured to cause the one or more processors to concurrently transmit the first user data on the first frequency band via the first set of transmitters in the first MIMO configuration and the second user data on the second frequency band via the second set of transmitters in the second MIMO configuration based on the operational characteristics being above a first threshold.

5. The non-transitory computer-readable medium of claim 1, wherein the first set of transmitters is configured to use a first pair of intra-band component carriers, and the second set of transmitters is configured to use a second pair of intra-band component carriers.

6. The non-transitory computer-readable medium of claim 1, wherein the first set of transmitters is configured to use a first intra-band component carrier and the second set of transmitters is configured to use a second intra-band component carrier based on the operational characteristics being below a second threshold.

7. The non-transitory computer-readable medium of claim 1, wherein the instructions when executed by the one or more processors, are configured to cause the one or more processors to receive an additional indication of an additional power class;
transmit third data on the first frequency band via the first set of transmitters in a first power class 1.5 configuration based on the addition indication; and
transmit fourth data on the second frequency band via the second set of transmitters in a second power class 1.5 configuration based on the additional indication.

8. The non-transitory computer-readable medium of claim 1, wherein the operational characteristics comprise an amount of data, a priority of the first user data, a priority of the second user data, a distance between the device and a base station, or a state of charge of a power source of the device.

9. A method, comprising:
receiving, via a receiver of a base station, a first indication of transmission capabilities of a user equipment;
transmitting, via a transmitter of the base station, a second indication of a power class and a plurality of frequency bands to the user equipment; and
sending and receiving, via the transmitter and the receiver, user data to and from the user equipment based on the first indication, the user equipment being configured to
transmit first user data using a first pair of transmitters in a first multi-in multi-out (MIMO) configuration using a first frequency band of the plurality of frequency bands, and
transmit second user data using a second pair of transmitters in a second MIMO configuration using a second frequency band of the plurality of frequency bands, the second frequency band being different from the first frequency band.

10. The method of claim 9, comprising determining, via processing circuitry of the base station, the power class and the plurality of frequency bands based on the first indication of the transmission capabilities of the user equipment.

11. The method of claim 10, wherein the user equipment is configured to
transmit third user data using the first pair of transmitters using a first power class 1.5 configuration based on the second indication, and
transmit fourth user data using the second pair of transmitters using a second power class 1.5 configuration based on the second indication.

12. The method of claim 11, comprising receiving, via the receiver, the first user data, the second user data, the third user data, and the fourth user data.

13. A user equipment, comprising:
at least one antenna;
at least one transmitter respectively coupled to the at least one antenna; and
processing circuitry coupled to the at least one transmitter and configured to
operate the at least one transmitter in a double multi-in multi-out (MIMO) configuration based on operational characteristics of the user equipment being above a threshold,
transmit first data via a first antenna of the at least one antenna on a first frequency band,
transmit second data via a second antenna of the at least one antenna on the first frequency band,
transmit third data via a third antenna of the at least one antenna on a second frequency band, and
transmit fourth data via a fourth antenna of the at least one antenna on the second frequency band.

14. The user equipment of claim 13, wherein each of the at least one antenna uses one intra-band component carrier based on the operational characteristics being below an additional threshold.

15. The user equipment of claim 13, wherein each of the at least one antenna uses two intra-band component carriers based on the operational characteristics being above an additional threshold.

16. The user equipment of claim 13, wherein the processing circuitry is configured to
operate the first antenna and the second antenna in the double MIMO configuration with switching based on operational characteristics of the user equipment being below the threshold,
transmit fifth data via the first antenna on the first frequency band,
transmit sixth data via the second antenna the first frequency band,
switch transmitting from the first frequency band to the second frequency band,
transmit seventh data via the first antenna on the second frequency band, and
transmit eighth data via the second antenna on the second frequency band.

17. The user equipment of claim 13, comprising:
at least one receiver respectively coupled to the at least one antenna; and
the processing circuitry coupled to the at least one receiver and configured to
receive an indication of a power class supported by a base station,
operate the at least one transmitter in a power class 1.5 (PC1.5) configuration based on the indication,
transmit fifth data via the first antenna and the second antenna on the first frequency band, and
transmit sixth data via the third antenna and the fourth antenna on the second frequency band.

18. The user equipment of claim 17, wherein the processing circuitry is configured to
operate the at least one transmitter in a MIMO configuration and the PC1.5 configuration based on the indication,
transmit seventh data and eight data via the first antenna and the second antenna on the first frequency band in the MIMO configuration, and
transmit ninth data via the third antenna and the fourth antenna on the second frequency band in the PC1.5 configuration.

19. The user equipment of claim 13, comprising
a first local oscillator coupled to a first transmitter of the at least one transmitter and a second transmitter of the at least one transmitter and configured to facilitate generating a first radio frequency (RF) signal by generating a first signal to modulate the first data and the second data in the first frequency band; and
a second local oscillator coupled to a third transmitter of the at least one transmitter and a fourth transmitter of the at least one transmitter and configured to facilitate generating a second RF signal by generating a second signal to modulate the third data and the fourth data in the second frequency band.

20. The user equipment of claim 13, wherein the operational characteristics comprise an amount of data, a priority of the data, a distance between the user equipment and a base station, or a state of charge of a power source of the user equipment.
